(19) United States
(12) Patent Application Publication
(10) Pub. No.: US 2013/0236015 A1
(43) Pub. Date: Sep. 12, 2013

(54) ENCRYPTION/DECRYPTION SYSTEM AND METHOD FOR A MOBILE DEVICE

(71) Applicant: GOTRUST TECHNOLOGY INC., Taichung City (TW)

(72) Inventors: Tien-Ji Li, Taichung City (TW); Cheng-Lung Li, Taichung City (TW)

(73) Assignee: GOTrust Technology Inc., Taichung City (TW)

(21) Appl. No.: 13/866,244

(22) Filed: Apr. 19, 2013

Related U.S. Application Data
(63) Continuation-in-part of application No. 13/035,739, filed on Feb. 25, 2011.

(51) Int. Cl. H04W 12/10

(52) U.S. Cl. CPC H04W 12/10
USPC 380/270

(57) ABSTRACT

An encryption/decryption system and method are provided for a mobile phone configured to make a voice packet encryption/decryption during mobile communication. The mobile phone has a connecting interface for an external plug-in device. The encryption/decryption system inside the external plug-in device at least has a control unit, and a security chip. When a security communication mode is activated, the communication between users can be prevented from being disclosed. The present invention is to provide the encryption/decryption system and method for activating a security communication mode between two mobile users communicating in mobile communication, and for preventing communication packets from being disclosed.

### CROSS REFERENCE TO RELATED APPLICATIONS

This application is a continuation-in-part of U.S. patent application Ser. No. 13/035,739, filed on Feb. 25, 2011, which is incorporated herewith by reference.

### BACKGROUND OF THE INVENTION

1. Field of the Invention

The present invention relates to an encryption/decryption system and method for a mobile phone, and more particularly to an encryption/decryption system and method for a mobile phone that is configured to make a voice packet encryption/decryption during mobile communication.

2. The Prior Arts

By the development of information industry, personal communication becomes more and more unsafe. According to recent articles, a Germany engineer announced that he has already cracked the encryption algorithm of mobile communication. The encryption technology is adapted for more than 21 years, and, among global 4.3 billion GSM mobile phones, eighty percent, i.e. 3.5 billion, GSM mobile phones use the security mechanism.

When GSM is adapted as a standard in 1988, a 64-bit encryption technology is adapted too, which is a simple technology referring to today's technology level. Although the GSM association upgrades the encryption technology to 128-bit system in 2007, most telecommunication proprietors do not upgrade immediate due to insufficient funds. Meanwhile, due to continuous society development, how to define preventing a secret from being disclosed today becomes a comprehensive issue, such as business secret protection, and also, the contents of secret becomes diversified.

### SUMMARY OF THE INVENTION

Accordingly, it is an object of the present invention to provide an encryption/decryption system and method for activating a security communication mode between two mobile users communicating in mobile communication, and for preventing communication packets from being disclosed.

Another objective of the present invention is to provide an encryption/decryption system and method applied in mobile communication without upgrading telecommunication equipment, and achieve secure mobile communication between two mobile users.

The above and other objects of the present invention are achieved by an encryption/decryption system and method inside an external plug-in device, wherein the external plug-in device is connected with a mobile phone through a connecting interface of the mobile phone. The encryption/decryption system at least comprises a control unit electrically connected with the mobile phone through the connecting interface; a security chip which is controlled by the control unit, and is configured to convert a digital code into a digital encrypted package, wherein the digital code is transmitted from the mobile phone through the connecting interface to the control unit and then from the control unit to the security chip, and the security chip then transmits the digital encrypted package to the mobile phone through the connecting interface via the control unit, and/or, the security chip is configured to decrypt a digital encrypted package into a digital code, wherein the digital encrypted package is transmitted from the mobile phone through the connecting interface to the control unit and then from the control unit to the security chip, and the security chip then transmits the digital code to the mobile phone through the connecting interface via the control unit.

Therefore, by realizing the aforementioned devices, the external plug-in device is connected to the mobile phone via the connecting interface. When the security communication mode is activated, the security chip of the encryption/decryption system inside the external plug-in device generates key and processes key exchanging. Then the encryption/decryption system of the external plug-in device is configured to encrypt/decrypt voice data for transmitting data to the calling party/called party.

Further, the security chip comprises a key system being configured to generate key and process key exchange. The external plug-in device can also comprise a flash memory inside for a user to store data.

### BRIEF DESCRIPTION OF THE DRAWINGS

The drawings disclose an illustrative embodiment of the present invention which serves to exemplify the various advantages and objects hereof, and are as follows:

FIG. 1 is a block diagram illustrating an encryption/decryption system according to the present invention;

FIG. 2 is a flowchart illustrating processes of an encryption/decryption method according to the encryption/decryption system of the present invention;

FIG. 3 schematically illustrates a preferred embodiment of encryption/decryption system according to the present invention;

FIG. 4 is a flowchart illustrating processes of an encryption/decryption method according to the embodiment in FIG. 3 of the encryption/decryption system of the present invention;

FIG. 5 is a block diagram illustrating system structure of a mobile phone;

FIG. 6 shows an encryption flow of the encryption/decryption system and the mobile phone;

FIG. 7 shows a decryption flow of the encryption/decryption system and the mobile phone; and

FIG. 8 shows another embodiment of the encryption/decryption system for a mobile phone.

### DETAILED DESCRIPTION OF THE PREFERRED EMBODIMENT

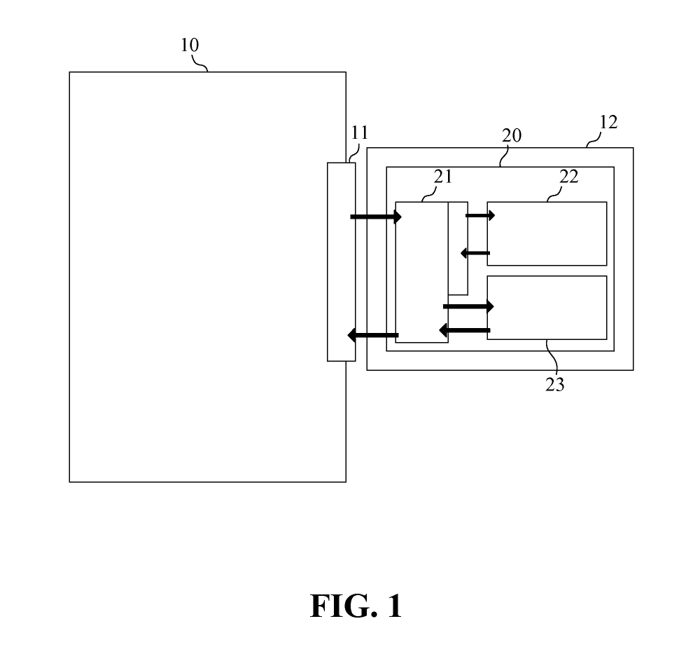

FIG. 1 is a block diagram illustrating an encryption/decryption system according to the present invention. As shown in FIG. 1, the encryption/decryption system 20 is inside an external plug-in device 12, and a mobile phone 10 has a connecting interface 11 for the external plug-in device 12 being connected to the mobile phone 10. The encryption/decryption system 20 at least comprises a control unit 21 electrically connected with the mobile phone 10 through the connecting interface 11;and, a security chip 22 which is controlled by the control unit 21, and is configured to encrypt a digital code into a digital encrypted package, wherein the digital code is transmitted from the mobile phone 10 through the connecting interface 11 to the control unit 21 and then from the control unit 21 to the security chip 22, and the security chip 22 then transmits the digital encrypted package to the mobile phone 10 through the connecting interface 11 via the control unit 21, and/or, the security chip 22 is configured to decrypt a digital encrypted package into a digital code, wherein the digital encrypted package is transmitted from the mobile phone 10 through the connecting interface 11 to the control unit 21 and then from the control unit 21 to the security chip 22, and the security chip 22 then transmits the digital code to the mobile phone 10 through the connecting interface 11 via the control unit 21.

The security chip 22 comprises a key system for generating keys and keys exchange. The present invention can further comprise a flash memory 23 inside the encryption/decryption system 20 of the external plug-in device 12 for a user to store data according to demands; therefore the control unit 21 can store digital data in the flash memory 23 according to user operation.

When the security communication mode is activated, the security chip 22 of the encryption/decryption system 20 inside the external plug-in device 12 generates key and processes key exchanging. Then the encryption/decryption system 10 of the external plug-in device 12 is configured to encrypt/decrypt voice data for transmitting data to the calling party/called party.

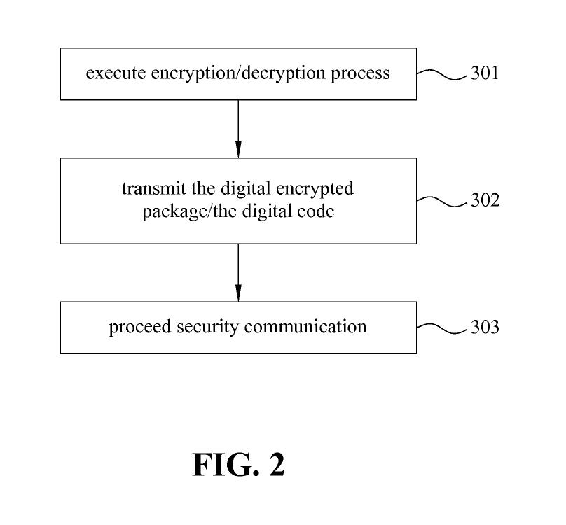

FIG. 2 is a flowchart illustrating processes of an encryption/decryption method according to the encryption/decryption system of the present invention. As shown in FIG. 2, at step 301, the security chip 22 executes encryption/decryption process. The security chip 22 encrypts a digital code into a digital encrypted package, wherein the digital code is transmitted from the mobile phone 10 through the connecting interface 11 to the control unit 21 and then from the control unit 21 to the security chip 22, and the security chip 22 then transmits the digital encrypted package to the control unit 21, and/or, the security chip 22 decrypts a digital encrypted package into a digital code, wherein the digital encrypted package is transmitted from the mobile phone 10 through the connecting interface 11 to the control unit 21 and then from the control unit 21 to the security chip 22, and the security chip 22 then transmits the digital code to the control unit 21.

In the second step 302, the control unit transmits the digital encrypted package/the digital code. The control unit 21 transmits the digital encrypted package to the mobile phone 10 through the connecting interface 11, and/or, the control unit 21 transmits the digital code to the mobile phone 10 through the connecting interface 11.

In step 303, proceeding security communication. In the mobile security communication between two mobile phone 10, the two mobile phone 10 generate random number, exchanges random number by PKI, and the security chip 22 of the encryption/decryption system 20 inside the plug-in the external plug-in device 12 proceeds encryption/decryption processes.

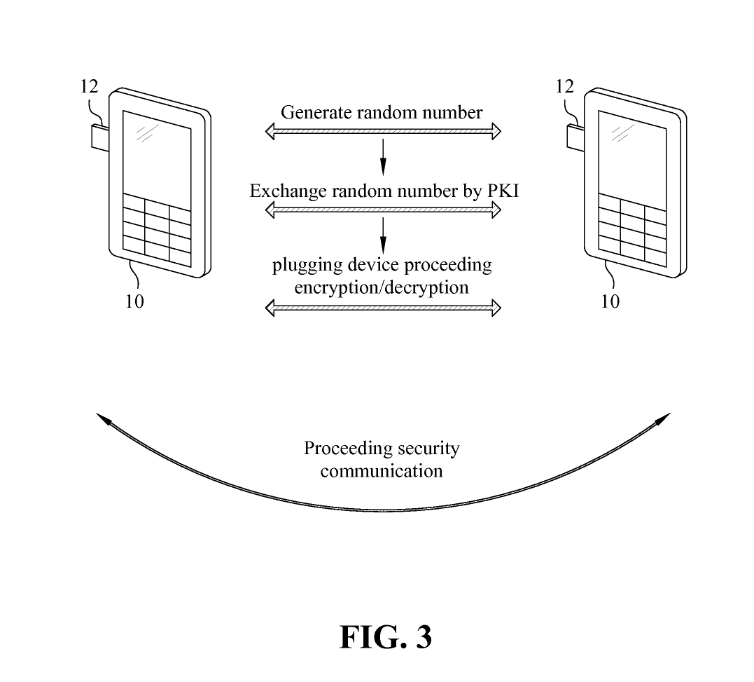

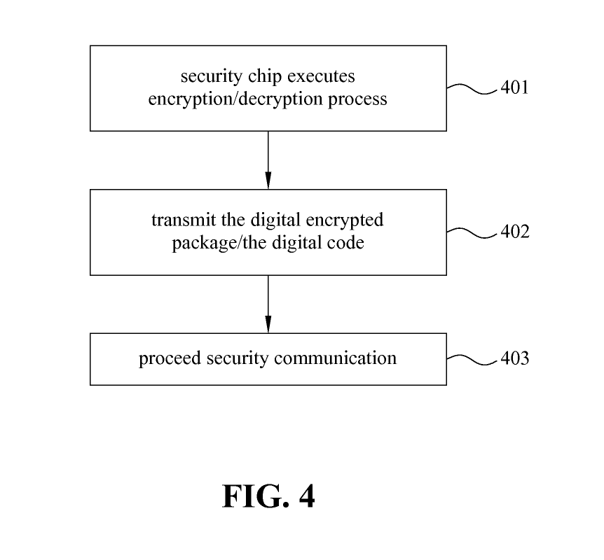

FIG. 3 schematically illustrates a preferred embodiment of encryption/decryption system according to the present invention. As shown in FIG. 4, when a user in calling party/called party side 3 and a user in called party/calling party side 4 use the encryption/decryption system 20 of the present invention, the external plug-in device 12 is connected to the mobile phone 10 via the connecting interface 11. By activating a security communication mode, the security chip 22 of the encryption/decryption system 20 inside the external plug-in device 12 is configured to generate keys and proceed keys exchange, and then the security chip 22 of the encryption/decryption system 20 inside the external plug-in device 12 is configured to encrypt/decrypt voice data for transmitting the data to the calling party/called party side 3 and the called party/calling party side 4.

FIG. 4 is a flowchart illustrating processes of an encryption/decryption method according to the embodiment in FIG. 3 of the encryption/decryption system of the present invention. As shown in FIG. 4, at step 401, in calling party/called party side 3 and in called party/calling party side 4, the security chip 22 executes encryption/decryption process. In calling party/called party side 3 and/or in called party/calling party side 4, the security chip 22 encrypts a digital code into a digital encrypted package, wherein the digital code is transmitted from the mobile phone 10 through the connecting interface 11 to the control unit 21 and then from the control unit 21 to the security chip 22, and the security chip 22 then transmits the digital encrypted package to the control unit 21, and, the security chip 22 decrypts a digital encrypted package into a digital code, wherein the digital encrypted package is transmitted from the mobile phone 10 in the called party/calling party side 4 and/or in the calling party/called party side 3. In called party/calling party side 4 and/or in the calling party/called party side 3, the security chip 22 encrypts a digital code into a digital encrypted package, wherein the digital code is transmitted from the mobile phone 10 through the connecting interface 11 to the control unit 21 and then from the control unit 21 to the security chip 22, and the security chip 22 then transmits the digital encrypted package to the control unit 21, and, the security chip 22 decrypts a digital encrypted package into a digital code, wherein the digital encrypted package is transmitted from the mobile phone 10 in the calling party/called party side 3 and/or in the called party/calling party side 4.

In the second step 402, the control unit 21 transmits the digital encrypted package/the digital code. In the calling party/called party side 3 and/or in the called party/calling party side 4, the control unit 21 transmits the digital encrypted package to the mobile phone 10 through the connecting interface 11, and/or, the control unit 21 transmits the digital code to the mobile phone 10 through the connecting interface 11.

In step 403, proceeding security communication. In the mobile security communication between two mobile phone 10 in the calling party/called party side 3 and/or in the called party/calling party side 4, the two mobile phone 10 generate random number, exchanges random number by PKI, and the security chip 22 of the encryption/decryption system 20 inside the plug-in the external plug-in device 12 proceeds encryption/decryption processes.

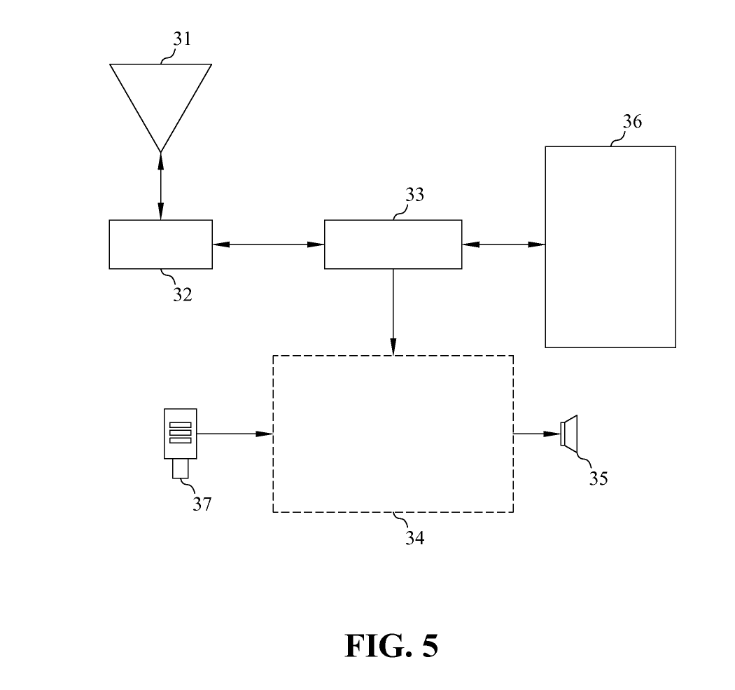

FIG. 5 is a block diagram illustrating system structure of a mobile phone. As shown in FIG. 5, the mobile phone 10 comprises an antenna 31, a RF Called party/Transmitter module 32, a baseband signal processing 33, a voice processing unit 34, a Multimedia speaker 35, an accessory 36, and a microphone 37. When the mobile phone 10 receives data, an antenna 31 transmits the received signal to a RF Called party/Transmitter module 32. The RF Called party/Transmitter module 32 proceeds the aforementioned signal by the baseband signal processing 33, and then transmits the result to a voice processing unit 34 for decoding. Finally the voice is transmitted to the called party by a Multimedia speaker 35. The mobile phone 10 has a connecting interface 11, and the user can freely select an accessory 36 for installing the external plug-in device 12 on the mobile phone 10. During transmission, the calling party transmits the voice via the microphone 37 to the voice processing unit 34 for being coded, and then the signal is transmitted to the baseband signal process 33. Then the converted signal is transmitted to the RF Called party/Transmitter module 32 for being transmitted by the antenna 31.

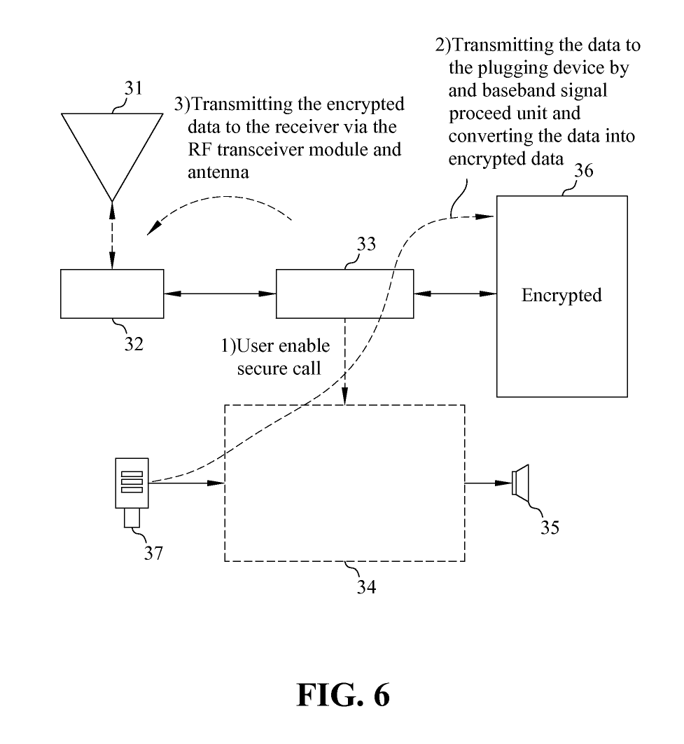

FIG. 6 shows an encryption flow of the encryption/decryption system and the mobile phone. In calling party/called party side and/or in called party/calling party side, the calling party installs the external plug-in device 12 on the mobile phone 10 via the connecting interface 11 of the accessories 36. When the calling party and the called party activate the security communication mode, the microphone 37 collects the calling party's voice and the voice processing unit 34 codes the voice data for being transmitted to the baseband signal processing 33. Then the coded information is transmitted to the external plug-in device 12, and the security chip 22 of the encryption/decryption system 20 inside the external plug-in device 12 then transmits the voice into a digital encrypted package. The digital encrypted package is then transmitted to the baseband signal processing 33 and transmitted to the RF Called party/Transmitter module 32 for being transmitted via the antenna 31.

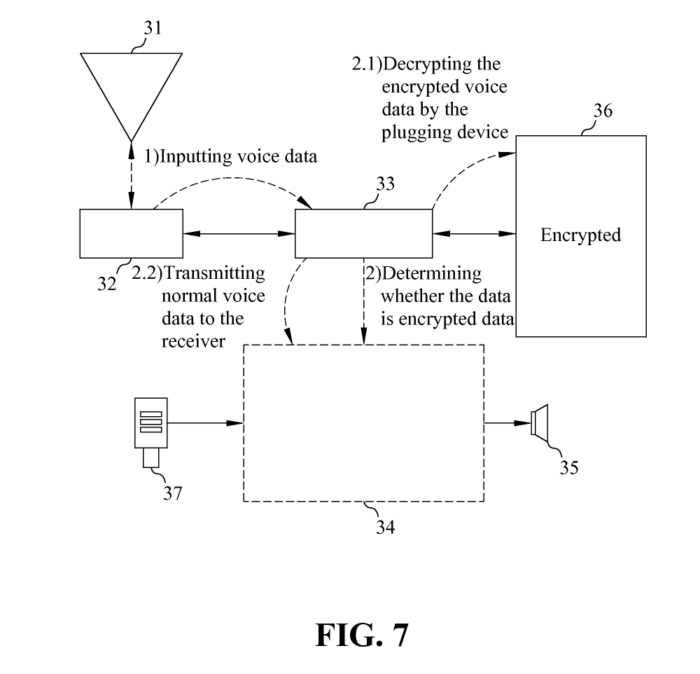

FIG. 7 shows a decryption flow of the encryption/decryption system and the mobile phone. The called party installs the external plug-in device 12 on the mobile phone 10 via the connecting interface 11 of the accessories 36. When the antenna 31 receives signal and transmits the signal to the RF transceiver 32, the baseband signal processing 33 is configured to determine whether the phone call is a security encrypted phone call. Once the phone call is not a security encrypted phone call, the received signal is then decoded by the voice processing unit 34 and the Multimedia speaker 35 plays the voice to the called party. Once the phone call is ensured to be a security encrypted phone call, the baseband signal processing 33 then transmits the digital encrypted package to the external plug-in device 20 for decryption. Then the decrypted coding information is transmitted to the voice processing unit 34 for being decoded and the Multimedia speaker 35 plays the voice to the called party. By the aforementioned embodiment, the security communication between the calling party and the called party is ensured.

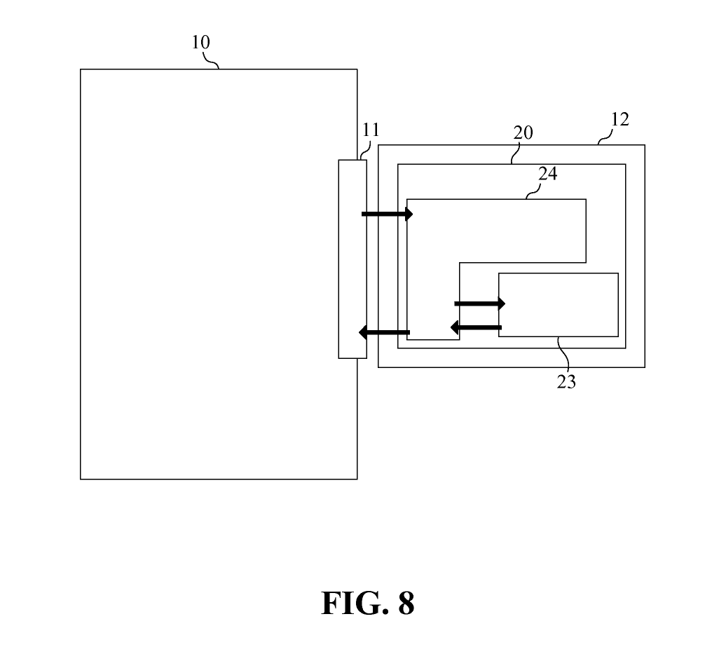

FIG. 8 shows another embodiment of the encryption/decryption system for a mobile phone. To save space and well arranging wires, the control unit 21 and the security chip 22 can be integrated as a multi-function chip 24. Therefore the aforementioned effects are also ensured as well as the space is saved and the manufacturing cost and malfunction rate are reduced.

Comparing with the conventional technologies, the present invention has advantages as follows.

1. The user can achieve security communication without waiting the Telecom operators to upgrade instruments.

2. The present invention is easy to operate. The user only needs to install the external plug-in device on the mobile phone and follow simple operation steps without additional training.

3. The present invention can be applied widely for the mobile phones with connecting device in the market.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An encryption/decryption system inside an external plug-in device, the external plug-in device being connected to a mobile phone through a connecting interface of the mobile phone, the encryption/decryption system at least comprising:
a control unit electrically connected with the mobile phone through the connecting interface; and
a security chip controlled by the control unit, and configured to encrypt a digital code into a digital encrypted package and to decrypt a digital encrypted package into a digital code;
wherein the digital code is transmitted from the mobile phone through the connecting interface to the control unit and then from the control unit to the security chip, and the security chip then transmits the digital encrypted package to the mobile phone through the connecting interface via the control unit, and the digital encrypted package is transmitted from the mobile phone through the connecting interface to the control unit and then from the control unit to the security chip and the security chip then transmits the digital code to the mobile phone through the connecting interface via the control unit.

2. The encryption/decryption system as claimed in claim 1, wherein the external plug-in device further comprises a flash memory for a user to store data.

3. The encryption/decryption system as claimed in claim 1, wherein the control unit is configured to be connected to the security chip via a security chip socket.

4. The encryption/decryption system as claimed in claim 1, wherein the security chip further comprises a key system being configured for exchanging keys during communication.

5. The encryption/decryption system as claimed in claim 1, wherein the control unit is further configured to be integrated with the security chip as a multi-function chip.

6. An encryption/decryption method comprising steps of:
executing encryption/decryption process;
transmitting digital encrypted package and/or digital code; and
proceeding security communication.

7. The encryption/decryption method as claimed in claim 6, wherein in the executing encryption/decryption process, a security chip encrypts a digital code into a digital encrypted package, the digital code is transmitted from a mobile phone through a connecting interface to the control unit and then from the control unit to the security chip and the security chip then transmits the digital encrypted package to the control unit, the security chip decrypts a digital encrypted package into a digital code, the digital encrypted package is transmitted from the mobile phone through the connecting interface to the control unit and then from the control unit to the security chip, and the security chip then transmits the digital code to the control unit.

8. The encryption/decryption method as claimed in claim 6, wherein in the transmitting digital encrypted package and/or digital code, a control unit transmits a digital encrypted package to a mobile phone through a connecting interface, and the control unit transmits a digital code to the mobile phone through the connecting interface.

9. The encryption/decryption method as claimed in claim 6, wherein in proceeding security communication step, two mobile phones generate random number, exchange random number by PKI, and a security chip of a encryption/decryption system inside an external plug-in device proceeds encryption/decryption processes.

10. An encryption/decryption method comprising steps of:
executing encryption/decryption process, wherein a security chip encrypts a digital code into a digital encrypted package, the digital code is transmitted from a mobile phone through a connecting interface to the control unit and then from the control unit to the security chip and the security chip then transmits the digital encrypted package to the control unit, the security chip decrypts a digital encrypted package into a digital code, the digital encrypted package is transmitted from the mobile phone through the connecting interface to the control unit and then from the control unit to the security chip, and the security chip then transmits the digital code to the control unit;
transmitting the digital encrypted package and/or the digital code, where the control unit transmits the digital encrypted package to the mobile phone through the connecting interface, and the control unit transmits the digital code to the mobile phone through the connecting interface; and
proceeding security communication, two mobile phones generate random number, exchange random number by PKI, and the security chip of a encryption/decryption system inside an external plug-in device proceeds encryption/decryption processes.
